(19) United States
(12) Patent Application Publication
(10) Pub. No.: US 2019/0302458 A1
(43) Pub. Date: Oct. 3, 2019

(54) PROJECTION TYPE DISPLAY DEVICE, CONTROL METHOD OF PROJECTION TYPE DISPLAY DEVICE, CONTROL PROGRAM OF PROJECTION TYPE DISPLAY DEVICE

(71) Applicant: FUJIFILM Corporation, Tokyo (JP)

(72) Inventor: Hiroyuki OSHIMA, Saitama (JP)

(73) Assignee: FUJIFILM Corporation, Tokyo (JP)

(21) Appl. No.: 16/445,218

(22) Filed: Jun. 19, 2019

Related U.S. Application Data
(63) Continuation of application No. PCT/JP2017/037549, filed on Oct. 17, 2017.

(30) Foreign Application Priority Data
Dec. 21, 2016 (JP) 2016-248119

(51) Int. Cl. G02B 27/01; B60K 35/00; E02F 9/26; H04N 9/31

(52) U.S. Cl. CPC G02B 27/0149; B60K 35/00; E02F 9/26; H04N 9/312; B60K 2370/52; G02B 2027/0159; B60K 2370/1529; B60K 2370/172; B60K 2370/66; H04N 9/3111

(57) ABSTRACT

Provided are a projection type display device, a control method of a projection type display device, and a control program of a projection type display device, capable of fixing a position of a combiner to a desired position to enhance usability without imposing a burden on an operator of a working machine. An HUD 100 includes a rotating part 15A that supports the combiner 12 to be rotatable between an in-use position and a withdrawal position, a locking mechanism 15B that prohibits rotation of the combiner 12, and a projection display section 50 that spatially modulates light emitted from a light source on the basis of image information, and projects image light obtained through the spatial modulation onto a projection surface 12A of the combiner 12 to display an image based on the image light, a locking mechanism controller 63 that controls the locking mechanism 15B on the basis of a traveling state of a construction machine 1 or an operating state of a bucket 4A.

### CROSS REFERENCE TO RELATED APPLICATION

This is a continuation of International Application No. PCT/JP2017/037549 filed on Oct. 17, 2017, and claims priority from Japanese Patent Application No. 2016-248119 filed on Dec. 21, 2016, the entire disclosures of which are incorporated herein by reference.

### BACKGROUND OF THE INVENTION

### 1. Field of the Invention

The present invention relates to a projection type display device, a control method of the projection type display device, and a computer readable medium storing a control program of the projection type display device.

### 2. Description of the Related Art

A vehicle head-up display (HUD) that projects, using a combiner disposed in the vicinity of a windshield of a vehicle such as an automobile, a train, a ship, a construction machine, an aircraft, or an agricultural machine, as a screen, light onto the screen to display an image is known (see JP2005-297619A, JP2006-248323A, JP2006-279800A, and JP2001-051228A). According to the HUD, it is possible to cause a driver to visually recognize an image based on light projected from the HUD as a real image on a screen or a virtual image in front of the screen.

JP2005-297619A and JP2006-248323A disclose an HUD that moves a combiner between an in-use position and a withdrawal position in an electrically driven manner.

JP2006-279800A and JP2001-051228A disclose an HUD that manually moves a combiner between an in-use position and a withdrawal position. The HUD has a locking mechanism that locks the combiner at the in-use position. The locking mechanism is configured so that a lock is manually released.

### SUMMARY OF THE INVENTION

As disclosed in JP2006-279800A and JP2001-051228A, in the HUD that manually moves the combiner, generally, the locking mechanism is provided so as not to move the combiner at an in-use position. However, such a locking mechanism is configured so that the lock is released as a user performs a manual operation for lock release. For this reason, there is a problem in that the operation for the lock release is complicated.

Even in a case where a so-called electromagnetic lock that electrically controls a locking mechanism is employed, it is necessary for a user to send an intention of lock release to a system through an operation of an operating button, or the like, and thus, it is difficult to solve inconvenience of an operation of the lock release.

Further, in the HUD that manually moves the combiner, a configuration in which a locking mechanism is provided so as not to move the combiner at the withdrawal position may be considered. In this case, release of the locking mechanism is complicated.

A configuration in which lock by a locking mechanism is released in an electrically driven manner in accordance with start-up of the HUD may be considered, but in this case, during the start-up of the HUD, it is not possible to lock the combiner at the withdrawal position, or it is necessary to perform an operation of locking the combiner at the withdrawal position. Further, during the start-up of the HUD, in a case where the combiner is returned to the withdrawal position, in order to return the combiner to the in-use position again, the above-mentioned lock release operation is necessary.

In a working machine such as heavy equipment, a construction machine, or an agricultural machine, since a vehicle body greatly shakes unlike a general vehicle such as an automobile, it is particularly necessary to lock a combiner at a desired position. However, as described above, although the locking mechanism is merely provided, it is not possible to enhance usability of the HUD.

The present invention has been made in consideration of the above-mentioned problems, and an object of the invention is to provide a projection type display device, a control method of the projection type display device, and a computer readable medium storing a control program of the projection type display device, capable of fixing a position of a combiner to a desired position to enhance usability without imposing a burden on an operator of a working machine.

According to an aspect of the invention, there is provided a projection type display device comprising: a combiner support that is provided in an operator cab of a working machine having a working tool and supports a combiner to be rotatable; a locking mechanism that prohibits rotation of the combiner; a locking mechanism controller that controls the locking mechanism; and a projection display section that spatially modulates light emitted from a light source on the basis of image information, and projects image light obtained through spatial modulation onto a projection surface of the combiner supported by the combiner support to display an image based on the image light, in which the combiner support supports the combiner to be rotatable from an in-use position where the projection surface is inserted onto an optical path of the image light to a withdrawal position where the projection surface is withdrawn from the optical path of the image light, and the locking mechanism controller controls the locking mechanism on the basis of a traveling state of the working machine or an operating state of the working tool.

According to another aspect of the invention, there is provided a control method of a projection type display device that includes a combiner support that is provided in an operator cab of a working machine having a working tool and supports a combiner to be rotatable, a locking mechanism that prohibits rotation of the combiner, and a projection display section that spatially modulates light emitted from a light source on the basis of image information, and projects image light obtained through spatial modulation onto a projection surface of the combiner supported by the combiner support to display an image based on the image light, in which the combiner support supports the combiner to be rotatable from an in-use position where the projection surface is inserted onto an optical path of the image light to a withdrawal position where the projection surface is withdrawn from the optical path of the image light, and the method comprises: a locking mechanism control step of controlling the locking mechanism on the basis of a traveling state of the working machine or an operating state of the working tool.

According to still another aspect of the invention, there is provided a computer readable medium storing a control program of a projection type display device that includes a combiner support that is provided in an operator cab of a working machine having a working tool and supports a combiner to be rotatable, a locking mechanism that prohibits rotation of the combiner, and a projection display section that spatially modulates light emitted from a light source on the basis of image information, and projects image light obtained through spatial modulation onto a projection surface of the combiner supported by the combiner support to display an image based on the image light, in which the combiner support supports the combiner to be rotatable from an in-use position where the projection surface is inserted onto an optical path of the image light to a withdrawal position where the projection surface is withdrawn from the optical path of the image light, and the control program causes a computer to execute: a locking mechanism control step of controlling the locking mechanism on the basis of a traveling state of the working machine or an operating state of the working tool.

According to the invention, it is possible to provide a projection type display device, a control method of the projection type display device, and a computer readable medium storing a control program of the projection type display device, capable of fixing a position of a combiner to a desired position to enhance usability without imposing a burden on an operator of a working machine.

### BRIEF DESCRIPTION OF THE DRAWINGS

FIG. 1 is a schematic diagram showing a configuration of a construction machine 1 in which an HUD 100 that is a projection type display device according to an embodiment of the invention is mounted.

FIG. 2 is a schematic diagram showing an example of an internal configuration of an operator cab 5 in the construction machine 1 shown in FIG. 1.

FIG. 3 is a schematic diagram showing a state where a front windshield 11 is seen from a cab seat 6 of the operator cab 5 in the construction machine 1 shown in FIG. 1.

FIG. 4 is a schematic diagram showing a combiner mounting part 15 and a combiner 12 that is mounted in the combiner mounting part 15, shown in FIGS. 2 and 3, seen in a gravity direction.

FIG. 5 is a schematic diagram showing a combiner mounting part 15 and a combiner 12 that is mounted in the combiner mounting part 15, shown in FIGS. 2 and 3, seen in a gravity direction.

FIG. 6 is a schematic diagram showing an internal configuration of a projection unit 10 shown in FIGS. 1 and 2.

FIG. 7 is a functional block diagram of a system controller 60 shown in FIG. 6.

FIG. 8 is a flowchart for illustrating an operation of the HUD 100 according to the embodiment of the invention.

FIG. 9 is a schematic diagram showing a combiner mounting part 150 that is a modification example of the combiner mounting part 15 of the HUD 100.

FIG. 10 is a flowchart for illustrating an operation of the HUD 100 that includes the combiner mounting part 150 shown in FIG. 9.

### DESCRIPTION OF THE PREFERRED EMBODIMENTS

Hereinafter, embodiments of the invention will be described with reference to the accompanying drawings.

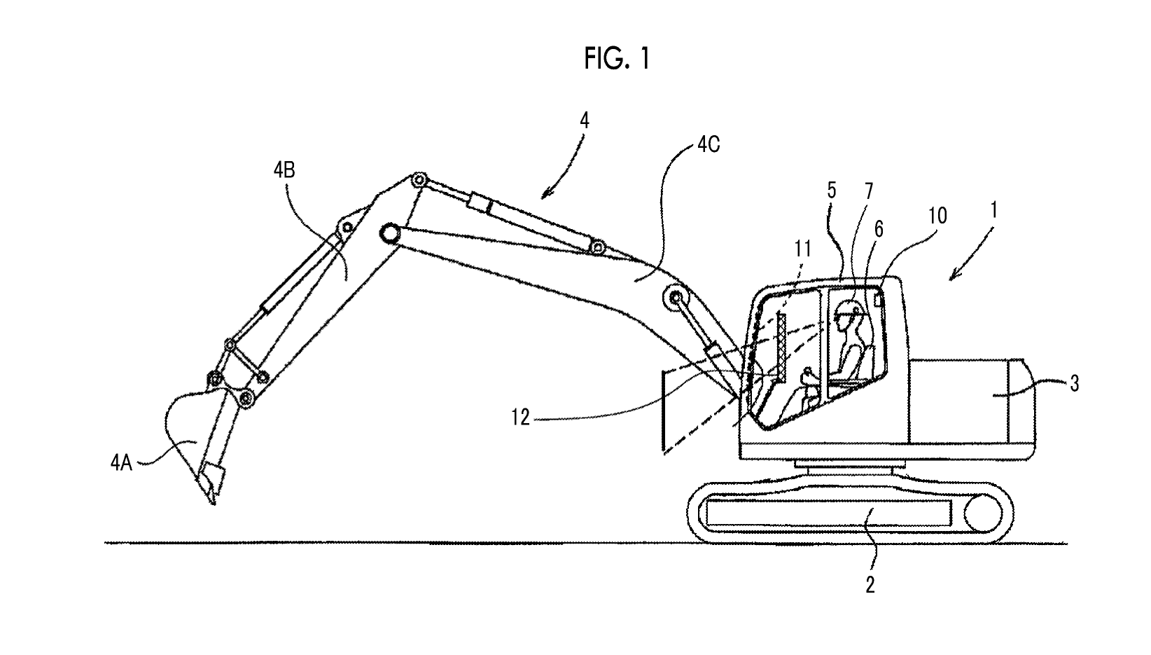

FIG. 1 is a schematic diagram showing a configuration of a construction machine 1 in which an HUD 100 that is a projection type display device according to a first embodiment of the invention is mounted.

The construction machine 1 is a hydraulic excavator, which includes respective parts of a lower traveling body 2, an upper revolving body 3 that is supported to be rotatable on the lower traveling body 2, a front working part 4 that is supported by the upper revolving body 3, and the like. The lower traveling body 2 and the upper revolving body 3 form a main part of the construction machine 1.

The lower traveling body 2 includes a metallic or rubber crawler for traveling a public road and a workplace.

The upper revolving body 3 includes an operator cab 5 in which an operating device for operating the front working part 4 and a cab seat 6 on which an operator is seated are provided.

In the operator cab 5, a front windshield 11 is provided in front of the cab seat 6 where an operator 7 is seated, and a combiner 12 is rotatably provided between the front windshield 11 and the cab seat 6.

A projection unit 10 that forms a projection type display device is provided in the operator cab 5, and causes the operator 7 who sits on the cab seat 6 to visually recognize a virtual image in front of the front windshield 11 using image light projected onto the combiner 12.

The front working part 4 includes an arm 4C that is movably supported by the upper revolving body 3 in a gravity direction and a direction (a vertical direction in the figure) perpendicular to the gravity direction, a boom 4B that is supported by the arm 4C to be rotatable with respect to the arm 4C, and a bucket 4A that is supported by the boom 4B to be rotatable with respect to the boom 4B. The bucket 4A is a part that is directly in contact with a working target such as a ground surface or a discharge, and forms a working tool.

A configuration in which a different working tool such as a steel cutter, a concrete crusher, a gripper, or a percussion type crushing tool, instead of the bucket 4A, is mounted in the boom 4B may be used.

The bucket 4A may be moved in the vertical direction in the figure with respect to the operator cab 5 through the arm 4C and the boom 4B. Further, the bucket 4A is rotatable using a direction (a direction vertical to a sheet plane in the figure) perpendicular to a sight direction of the worker who sits on the cab seat 6 and the gravity direction as an axis. Further, the boom 4B is rotatable using the direction vertical to the sheet plane in the figure as an axis.

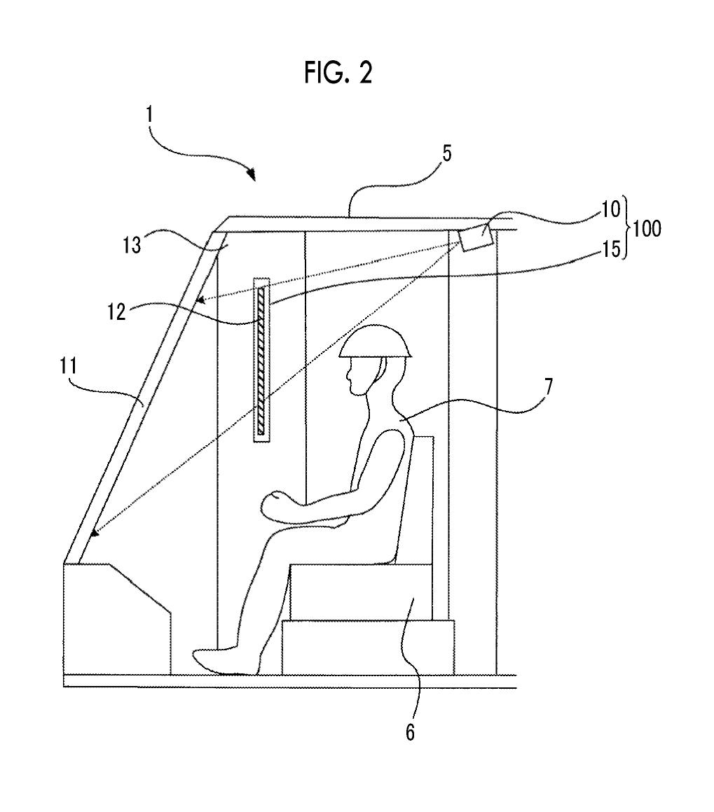

FIG. 2 is a schematic diagram showing an example of an internal configuration of the operator cab 5 in the construction machine 1 shown in FIG. 1.

As shown in FIG. 2, the HUD 100 includes a projection unit 10, a combiner mounting part 15, and the combiner 12. The combiner mounting part 15 is fixed to a right side pillar 13 of the operator cab 5. The combiner 12 is attachably and detachably provided in the combiner mounting part 15.

The projection unit 10 is provided on an upper and rear side of the operator 7 in a state where the operator 7 sits on the cab seat 6, and projects image light onto the combiner 12 mounted in the combiner mounting part 15.

The operator 7 of the construction machine 1 can view image light that is projected onto the combiner 12 that is mounted in the combiner mounting part 15 and is reflected therefrom visually recognize information on an icon, characters, or the like for supporting an operation of the construction machine 1 as a virtual image. Further, the combiner 12 has a function of reflecting the image light projected from the projection unit 10 and transmitting light from the outside (outside world). Accordingly, the worker can visually recognize the virtual image based on the image light projected from the projection unit 10 and an outside scene in an overlapping manner.

In the example shown in FIG. 1, the HUD 100 is mounted in a hydraulic excavator, but the HUD 100 may be similarly mounted in a working machine (for example, a wheel loader, a bulldozer, a motor grader, a forklift, or the like) in which a working tool capable of being operated by an operator is mounted in front of the cab seat 6.

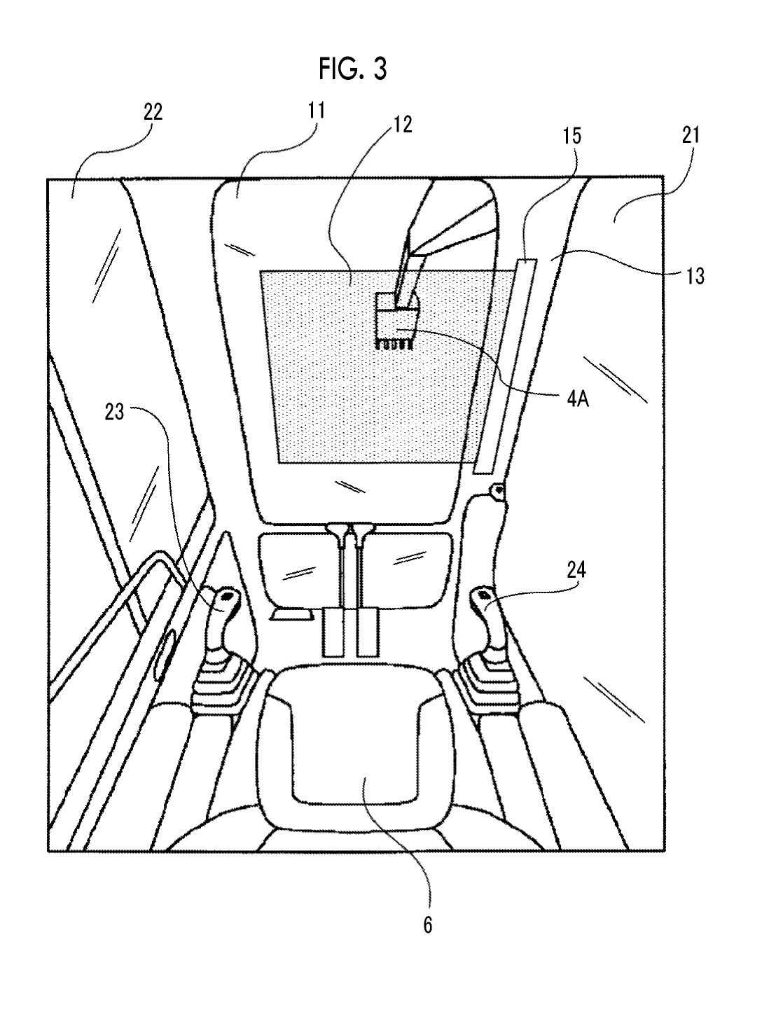

FIG. 3 is a schematic diagram showing a state where the front windshield 11 is seen from the cab seat 6 of the operator cab 5 in the construction machine 1 shown in FIG. 1.

The operator cab 5 is surrounded by the front windshield 11, a right side windshield 21, and a left side windshield 22. The operator cab 5 includes a left operation lever 23 for operating bending and stretching of the front working part 4 and revolution of the upper revolving body 3, a right operation lever 24 for operating drilling and opening of the bucket 4A of the front working part 4, and the like, around the cab seat 6.

Allocation of operational functions to the left operation lever 23 and the right operation lever 24 is an example, and the invention is not limited thereto. The left operation lever 23 and the right operation lever 24 form an operation member for performing operations of the bucket 4A such as movement of the bucket 4A, drilling using the bucket 4A, and opening of the bucket 4A.

The right side pillar 13 is provided between the front windshield 11 and the right side windshield 21, and the combiner mounting part 15 is fixed to the right side pillar 13.

Although not shown in the figures, the construction machine 1 includes a steering wheel, an accelerator, a brake, and the like for running that are operated when the construction machine 1 travels on a public road or the like using the lower traveling body 2.

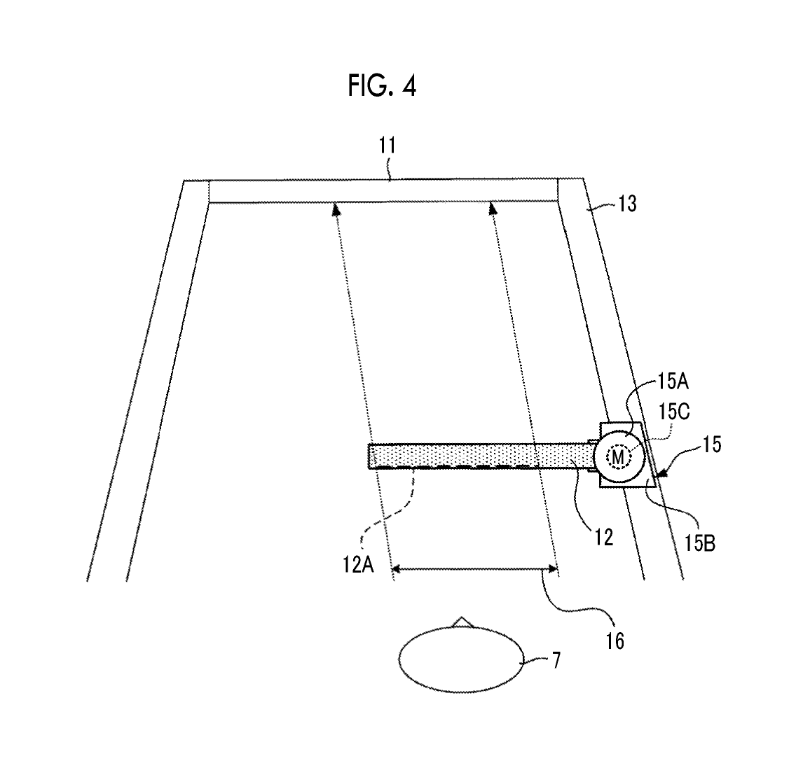

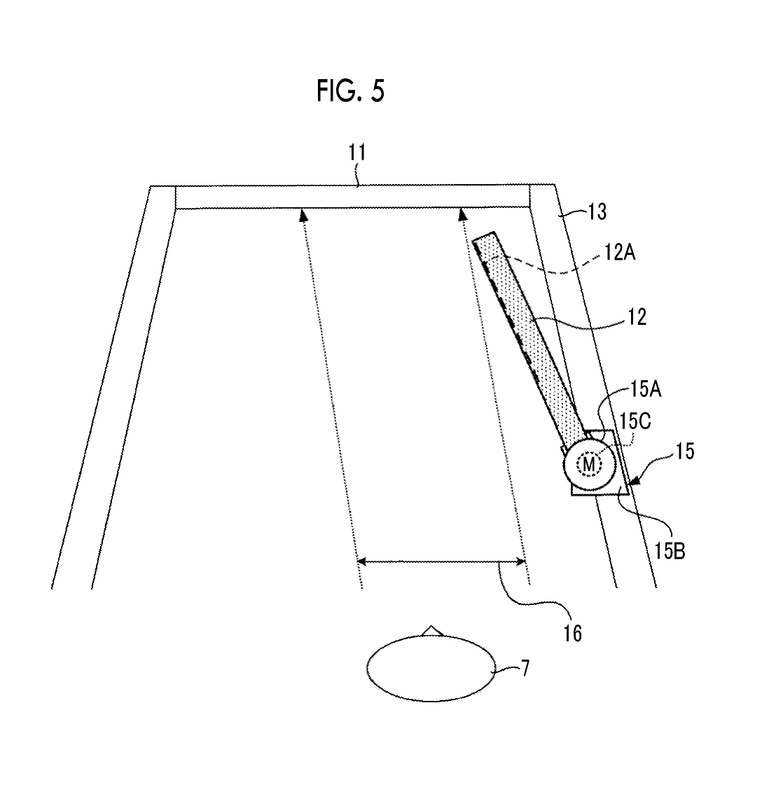

FIG. 4 and FIG. 5 are schematic diagrams showing the combiner mounting part 15 and the combiner 12 that is mounted in the combiner mounting part 15, shown in FIGS. 2 and 3, seen in a gravity direction, in which FIG. 4 shows a state where the combiner 12 is in an in-use position, and FIG. 5 shows a state where the combiner 12 is in a withdrawal position.

The combiner mounting part 15 includes a rotating part 15A to which the combiner 12 is attachably and detachably connected, which is configured of a torque hinge or the like that is rotatable centering around an axis along the gravity direction, a locking mechanism 15B that supports the rotating part 15A and prohibits rotation of the rotating part 15A, and a motor 15C that is a drive section for rotationally moving the rotating part 15A in an electrically driven manner.

The rotating part 15A supports the combiner 12 mounted in the rotating part 15A to be rotatable between the in-use position shown in FIG. 4 and the withdrawal position shown in FIG. 5. The rotating part 15A forms a combiner support.

As shown in FIG. 4, the in-use position refers to a position of the combiner 12 in a state where a projection surface 12A of the combiner 12 is inserted on an optical path 16 of image light projected from the projection unit 10 so that a virtual image based on the image light can be visually recognized by the operator 7.

As shown in FIG. 5, the withdrawal position refers to a position where the projection surface 12A of the combiner 12 is withdrawn from the optical path 16 of the image light projected from the projection unit 10.

The rotating part 15A is electrically rotatable by the motor 15C, but in a state where the motor 15C is not operated, by applying a force to the combiner 12, it is possible to manually move the combiner 12 between the in-use position and the withdrawal position.

The locking mechanism 15B is configured of an electromagnetic lock that electromagnetically prohibits the rotation of the rotating part 15A, and is controlled by a system controller 60 (which will be described later) of the projection unit 10. The locking mechanism 15B is able to prohibit the rotation of the rotating part 15A in a state where the combiner 12 is at the in-use position shown in FIG. 4 and in a state where the combiner 12 is at the withdrawal position shown in FIG. 5, respectively.

Although not shown in the figures, the combiner mounting part 15 is provided with a position detector for detecting whether the position of the combiner 12 is the in-use position or the withdrawal position. For example, the position detector is configured of a switch that outputs an in-use position signal in a case where the combiner 12 is at the in-use position, and a switch that outputs a withdrawal position signal in a case where the combiner 12 is at the withdrawal position.

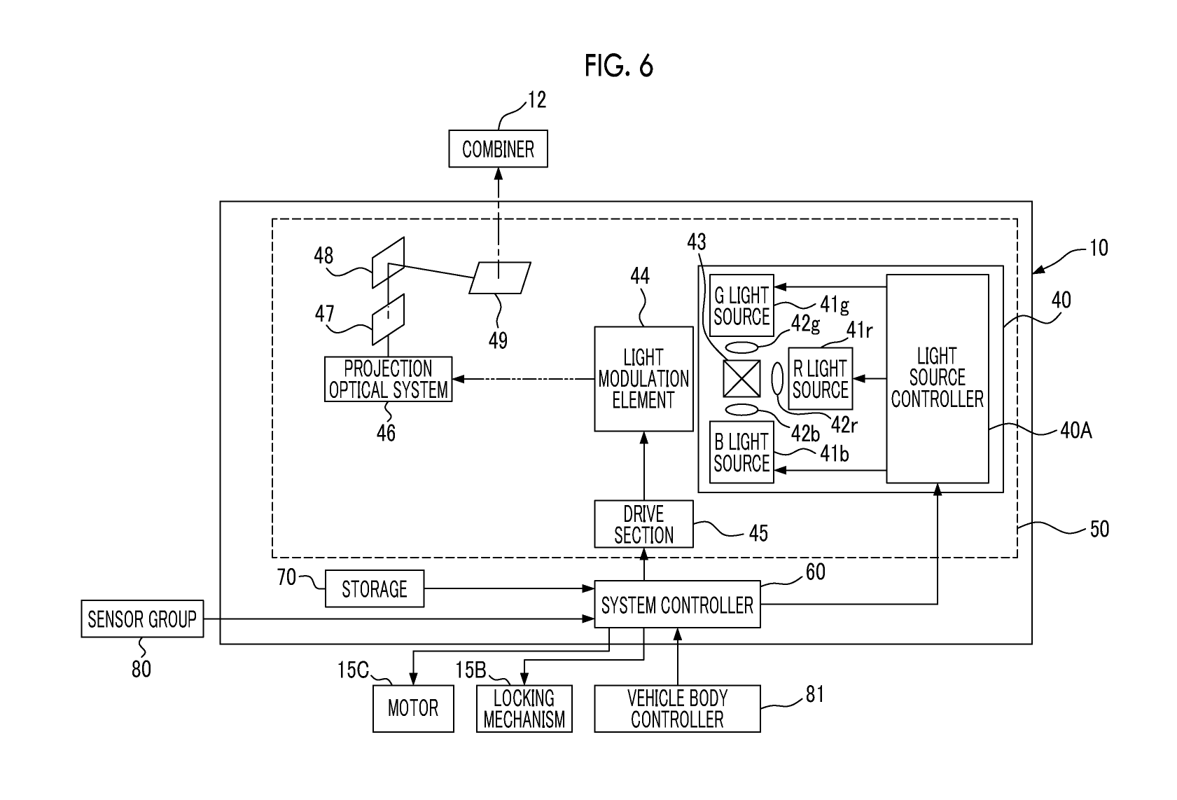

FIG. 6 is a schematic diagram showing an internal configuration of the projection unit 10 shown in FIGS. 1 and 2.

The projection unit 10 includes a light source unit 40, a light modulation element 44, a drive section 45 that drives the light modulation element 44, a projection optical system 46, a diffuser 47, a reflecting mirror 48, a magnifier 49, a system controller 60 that controls the light source unit 40 and the drive section 45, and a storage 70 configured of a storage medium such as a flash memory.

The light source unit 40 includes a light source controller 40A, an R light source 41r that is a red light source that emits red light, a G light source 41g that is a green light source that emits green light, a B light source 41b that is a blue light source that emits blue light, a dichroic prism 43, a collimator lens 42r that is provided between the R light source 41r and the dichroic prism 43, a collimator lens 42g that is provided between the G light source 41g and the dichroic prism 43, and a collimator lens 42b that is provided between the B light source 41b and the dichroic prism 43.

The dichroic prism 43 is an optical member for guiding light emitted from each of the R light source 41r, the G light source 41g, and the B light source 41b to the same optical path. That is, the dichroic prism 43 transmits red light that is collimated by the collimator lens 42r to be output to the light modulation element 44. Further, the dichroic prism 43 reflects green light that is collimated by the collimator lens 42g to be output to the light modulation element 44. In addition, the dichroic prism 43 reflects blue light that is collimated by the collimator lens 42b to be output to the light modulation element 44. An optical member having such a function is not limited to a dichroic prism. For example, a cross dichroic mirror may be used.

The R light source 41r, the G light source 41g, and the B light source 41b may respectively employ a light emitting element such as a laser or a light emitting diode (LED). The R light source 41r, the G light source 41g, and the B light source 41b form light sources of the projection type display device. In this embodiment, the light sources of the projection type display device are configured to include three light sources of the R light source 41r, the G light source 41g, and the B light source 41b, but the number of light sources may be 1, 2, or 4 or more.

The light source controller 40A sets the intensity of light emitted from each of the R light source 41r, the G light source 41g, and the B light source 41b to a predetermined light intensity pattern, and performs a control for sequentially emitting light from the R light source 41r, the G light source 41g, and the B light source 41b according to the light intensity patterns.

The light modulation element 44 spatially modulates light that is emitted from the dichroic prism 43 on the basis of image information, and emits the spatially modulated light (red color image light, blue color image light, and green color image light) to the projection optical system 46.

The light modulation element 44 may employ, for example, a liquid crystal on silicon (LCOS), a digital micromirror device (DMD), a micro electro mechanical systems (MEMS) element, a liquid crystal display device, or the like.

The drive section 45 drives the light modulation element 44 on the basis of image information input from the system controller 60, and causes light (red color image light, blue color image light, and green color image light) based on the image information to be output to the projection optical system 46.

The light modulation element 44 and the drive section 45 form a light modulator of the projection type display device.

The projection optical system 46 is an optical system that projects light emitted from the light modulation element 44 of the light source unit 40 to the diffuser 47. The optical system is not limited to a lens, and may employ a scanner. For example, light emitted from a scan type scanner may be diffused by the diffuser 47 to become a plane light source.

The reflecting mirror 48 reflects the light diffused by the diffuser 47 toward the magnifier 49.

The magnifier 49 magnifies an image based on the light reflected from the reflecting mirror 48 to be projected onto the combiner 12.

The light source unit 40, the light modulation element 44, the drive section 45, the projection optical system 46, the diffuser 47, the reflecting mirror 48, and the magnifier 49 form a projection display section 50 that spatially modulates light emitted from the R light source 41r, the G light source 41g, and the B light source 41b on the basis of image information input from the system controller 60 and projects image light obtained through the spatial modulation onto the combiner 12 mounted in the combiner mounting part 15 to display a virtual image based on the image light.

The system controller 60 controls the light source controller 40A and the drive section 45 so that image light based on image information is emitted to the diffuser 47 through the projection optical system 46.

The diffuser 47, the reflecting mirror 48, and the magnifier 49 shown in FIG. 6 are optically designed so that an image based on image light projected onto the combiner 12 can be visually recognized as a virtual image at a position in front of the combiner 12.

The system controller 60 is configured of a variety of processors as main components, and includes a read only memory (ROM) in which a program for executing the processors is stored, a random access memory (RAM) that is a work memory, and the like.

The variety of processors includes a central processing unit (CPU) that is a general-purpose processor that performs a variety of processes by executing a program, a programmable logic device (PLD) that is a processor capable of changing a circuit configuration after manufacturing, such as a field programmable gate array (FPGA), an exclusive electric circuit that is a processor that has a circuit configuration that is exclusively designed for executing a specific process, such as an application specific integrated circuit (ASIC), or the like.

A structure of the variety of processors is, more specifically, an electric circuit in which circuit elements such as semiconductor devices are combined.

A processor of the system controller 60 may be configured as one processor among a variety of processors, or may be configured as a combination of the same kind or different kinds of two or more processors (for example, a combination of a plurality of FPGAs or a combination of a CPU and an FPGA).

The storage 70 stores a plurality of pieces of work support information. The work support information refers to information or the like that is displayed in the vicinity of the bucket 4A that is frequently watched by an operator during work and supports efficient progress of the work. The work support information includes characters or an arrow indicating a drilling direction of the bucket 4A, characters or a scale indicating the amount of drilling (OO m), warning information for calling operator's attention, or the like.

A vehicle body controller 81 shown in FIG. 6 generally controls the construction machine 1. The vehicle body controller 81 inputs position information from a global positioning system (GPS) receiver (not shown) provided in the construction machine 1, information on a traveling speed of the construction machine 1, information indicating the presence or absence of an operation of the arm 4C, the boom 4B, or the bucket 4A of the construction machine 1, information indicating the presence or absence of a revolving operation of the upper revolving body 3 of the construction machine 1, or the like, to the system controller 60.

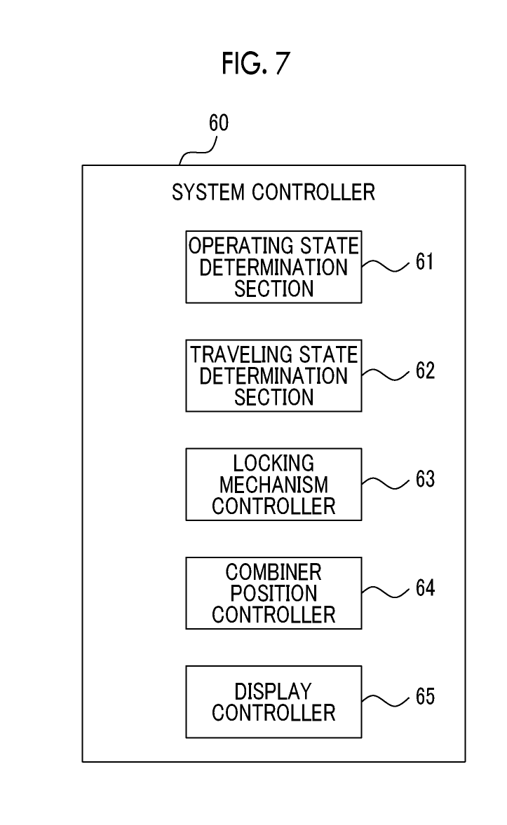

FIG. 7 is a functional block diagram of the system controller 60 shown in FIG. 6.

The system controller 60 includes an operating state determination section 61, a traveling state determination section 62, a locking mechanism controller 63, a combiner position controller 64, and a display controller 65. The operating state determination section 61, the traveling state determination section 62, the locking mechanism controller 63, the combiner position controller 64, and the display controller 65 are functional blocks formed by executing a program including a control program stored in a ROM by a processor of the system controller 60.

The operating state determination section 61 determines an operating state of the bucket 4A on the basis of the information indicating the presence or absence of the operation of the arm 4C, the boom 4B, or the bucket 4A input from the vehicle body controller 81, and the information indicating the presence or absence of revolution of the upper revolving body 3.

The operating state of the bucket 4A includes an operation execution state where the operation of the bucket 4A (a drilling operation of the bucket 4A, an opening operation of the bucket 4A, or an operation for moving the bucket 4A (an operation of the boom 4B, an operation of the arm 4C, or a revolving operation of the upper revolving body 3)) is executed, and an operation non-execution state where the operation of the bucket 4A is not executed.

In a case where information indicating that the drilling operation or the opening operation of the bucket 4A is performed is input, in a case where information indicating that the boom 4B or the arm 4C is operated is input, or in a case where information indicating that the upper revolving body 3 is in a revolution operation is input, the operating state determination section 61 determines that the operating state of the bucket 4A is the operation execution state.

In a case where the information indicating that the drilling operation or the opening operation of the bucket 4A is not performed, the information indicating that the boom 4B or the arm 4C is operated, and the information indicating that the upper revolving body 3 is in the revolution operation are not input, the operating state determination section 61 determines that the operating state of the bucket 4A is the operation non-execution state.

In the construction machine 1, a sensor that detects contact with an object may be provided in an operation member (the left operation lever 23 and the right operation lever 24 shown in FIG. 3) for operating the bucket 4A, and the operating state determination section 61 may determine the operating state of the bucket 4A on the basis of information from the sensor.

Specifically, in a case where information indicating that the contact with the object is detected is input from the sensor, the operating state determination section 61 determines that the operating state of the bucket 4A is the operation execution state, and in a case where the information indicating that the contact with the object is detected is not input from the sensor, the operating state determination section 61 determines that the operating state of the bucket 4A is the operation non-execution state.

The traveling state determination section 62 determines a traveling state of the construction machine 1 on the basis of information on a current position input from the vehicle body controller 81 and information on a traveling speed. The traveling state of the construction machine 1 includes a stopping state and a moving state.

The stopping state refers to a state where the traveling speed of the construction machine 1 or a position variation of the construction machine 1 is equal to or smaller than a threshold, that is, a state where the construction machine 1 is stopped or finely moves in a working process in a workplace.

The moving state refers to a state where the traveling speed of the construction machine 1 or the position variation of the construction machine 1 exceeds the threshold, that is, a state where the construction machine 1 travels on, for example, a public road to move from a certain point to another point spaced by a distance that exceeds a predetermined distance.

The traveling state determination section 62 may calculate the traveling speed of the construction machine 1 on the basis of positional information from the GPS receiver provided in the construction machine 1, and may determine the traveling state on the basis of the calculated traveling speed.

The locking mechanism controller 63 controls the locking mechanism 15B on the basis of the operating state of the bucket 4A determined by the operating state determination section 61, or the traveling state of the construction machine 1 determined by the traveling state determination section 62.

The combiner position controller 64 controls the motor 15C to control the position of the combiner 12 mounted in the rotating part 15A.

The display controller 65 controls image information input to the drive section 45 to control a virtual image to be displayed by the projection display section 50. The display controller 65 causes work support information read out from the storage 70 to be included in the image information, to thereby cause the projection display section 50 to display a virtual image based on the work support information.

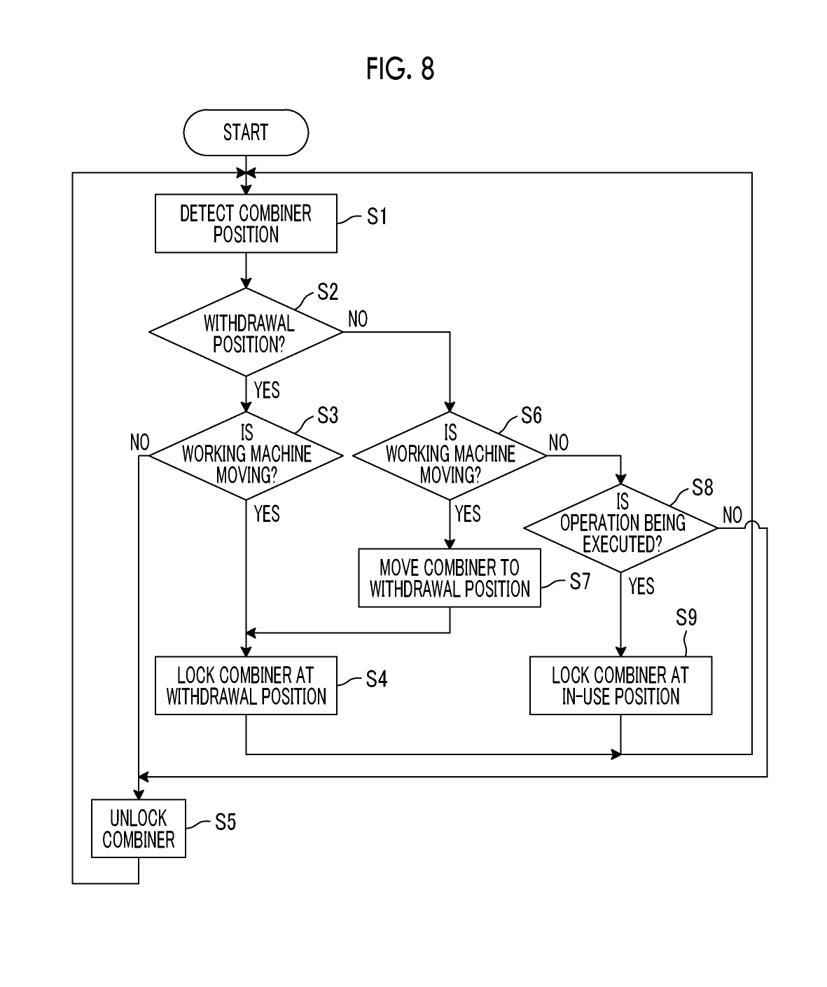

FIG. 8 is a flowchart for illustrating an operation of the HUD 100 according to this embodiment.

First, the system controller 60 detects the position of the combiner 12 on the basis of a signal output from the position detector of the combiner mounting part 15 (step S1).

Then, the locking mechanism controller 63 determines whether the position detected in step S1 is the withdrawal position (step S2).

In a case where the position of the combiner 12 is the withdrawal position (YES in step S2), the traveling state determination section 62 determines whether the traveling state of the construction machine 1 is the moving state (step S3).

In a case where the traveling state of the construction machine 1 is the moving state (YES in step S3), the locking mechanism controller 63 operates the locking mechanism 15B to prohibit rotation of the rotating part 15A, and locks the position of the combiner 12 at the withdrawal position (step S4).

On the other hand, in a case where the traveling state of the construction machine 1 is the stopping state (NO in step S3), the locking mechanism controller 63 controls the rotation of the rotating part 15A in a permission state without operating the locking mechanism 15B, and unlocks the position of the combiner 12 (step S5). After step S5, the procedure returns to step S1.

In step S2, in a case where the position of the combiner 12 is the in-use position (NO in step S2), the traveling state determination section 62 determines whether the traveling state of the construction machine 1 is the moving state (step S6).

In a case where the traveling state of the construction machine 1 is the moving state (YES in step S6), the combiner position controller 64 controls the motor 15C to rotate the rotating part 15A, and moves the combiner 12 to the withdrawal position (step S7). After step S7, the combiner 12 is locked at the withdrawal position by the locking mechanism controller 63 (step S4). After step S4, the procedure returns to step S1.

On the other hand, in a case where the traveling state of the construction machine 1 is the stopping state (NO in step S6), the operating state determination section 61 determines whether the operating state of the bucket 4A is the operation execution state (step S8).

In a case where the operating state of the bucket 4A is the operation execution state (YES in step S8), the locking mechanism controller 63 operates the locking mechanism 15B to prohibit the rotation of the rotating part 15A, and locks the position of the combiner 12 at the in-use position (step S9). After step S9, the procedure returns to step S1.

On the other hand, in a case where the operating state of the bucket 4A is the operation non-execution state (NO in step S8), the locking mechanism controller 63 controls the rotation of the rotating part 15A in a permission state without operating the locking mechanism 15B, and unlocks the position of the combiner 12 (step S5).

As described above, according to the HUD 100, in a case where the combiner 12 is at the withdrawal position and the construction machine 1 is moved for a purpose other than work, the position of the combiner 12 is locked at the withdrawal position by the locking mechanism 15B. Accordingly, when the construction machine 1 is moving, it is possible to prevent the combiner 12 from being moved between the withdrawal position and the in-use position due to vibration of a vehicle body, for example. Thus, during movement of the construction machine 1, it is possible to confirm a front side of the front windshield 11 without through the combiner 12, to thereby enhance visibility. Consequently, it is possible to enhance safety of the construction machine 1 that is moving.

Further, according to the HUD 100, in a case where the combiner 12 is at the withdrawal position and the construction machine 1 is, for example, being stopped, the position of the combiner 12 is not locked. Accordingly, in a case where the combiner 12 is moved from the withdrawal position to the in-use position to start the operation or work is suspended and the combiner 12 is moved from the in-use position to the withdrawal position, an operator can smoothly change the position of the combiner 12 in accordance with an operator's intention.

In addition, according to the HUD 100, in a case where the combiner 12 is at the in-use position and construction machine 1 is moving, the combiner 12 is moved at the withdrawal position to be locked. That is, when an operator terminates work and leaves a workplace using the construction machine 1, even in a case where the combiner 12 is still at the in-use position, the construction machine 1 starts moving, and the combiner 12 is automatically moved to the withdrawal position to be locked. Thus, it is possible to enhance forward visibility during movement without imposing a burden on the operator.

Further, according to the HUD 100, in a case where the combiner 12 is at the in-use position and the bucket 4A is in the operation execution state where the operation of the bucket 4A is executed, the position of the combiner 12 is locked at the in-use position by the locking mechanism 15B. Thus, it is possible to prevent the combiner 12 from being moved between the withdrawal position and the in-use position due to vibration of a vehicle body that is being operated, and thus, to enhance visibility of a virtual image displayed by the HUD 100, and to enhance work efficiency.

In addition, according to the HUD 100, in a case where the combiner 12 is at the in-use position the construction machine 1 is, for example, being stopped, and the bucket 4A is in the operation non-execution state where the operation of the bucket 4A is not executed, the position of the combiner 12 is not locked. Thus, even during work, it is possible to suspend the work to move the combiner 12 to the withdrawal position to specifically confirm a front side thereof, to thereby enhance work efficiency.

In the operation shown in FIG. 8, the processes of step S6 and step S7 are not essential, and may not be performed. That is, in FIG. 8, in a case where the determination of step S2 is NO, the process of step S8 may not be performed.

Further, in the operation shown in FIG. 8, the processes of step S8 and step S9 are not essential, and may not be performed. That is, in FIG. 8, in a case where the determination of step S6 is NO, the process of step S5 may not be performed.

In addition, in FIG. 8, in a case where the determination of step S3 is NO, the combiner position controller 64 may control the motor 15C to rotate the rotating part 15A, and thus, the combiner 12 may be moved to the in-use position, and then, the process of step S5 may be performed.

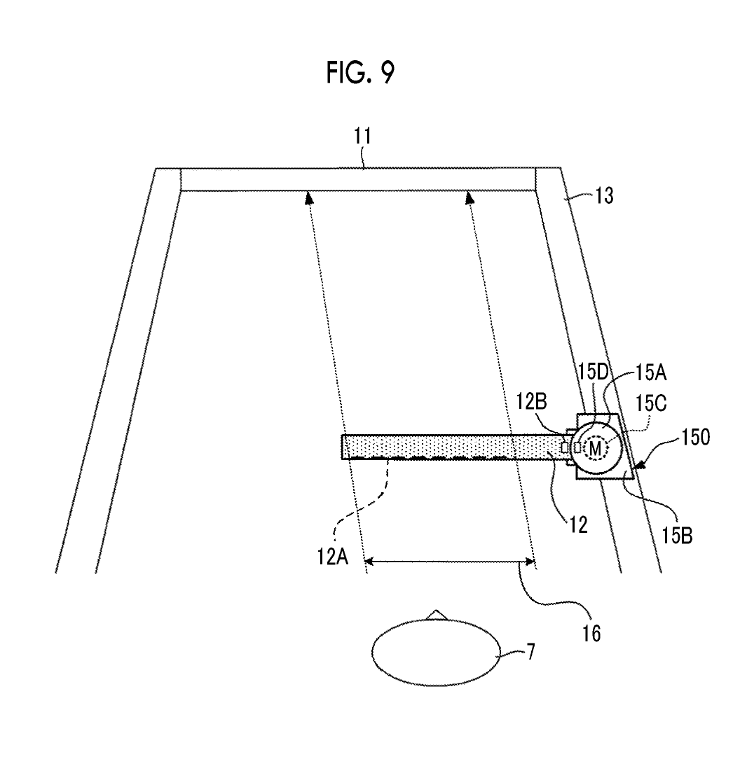

FIG. 9 is a schematic diagram showing a combiner mounting part 150 that is a modification example of the combiner mounting part 15 of the HUD 100.

The combiner mounting part 150 has the same configuration as that of the combiner mounting part 15 except that a wireless tag reader 15D is additionally provided in the rotating part 15A. A wireless tag 12B that stores identification information for identifying the combiner 12 is fixed to the combiner 12 mounted in the combiner mounting part 150.

The combiner mounting part 150 is configured so that any one of a plurality of combiners 12 having different transmittances is capable of being mounted therein. Further, the wireless tag 12B that stores identification information is fixed to each of all the combiners capable of being mounted in the combiner mounting part 150. The wireless tag reader 15D reads out the identification information stored in the wireless tag 12B of the combiner 12 mounted in the combiner mounting part 150, and transmits the result to the system controller 60.

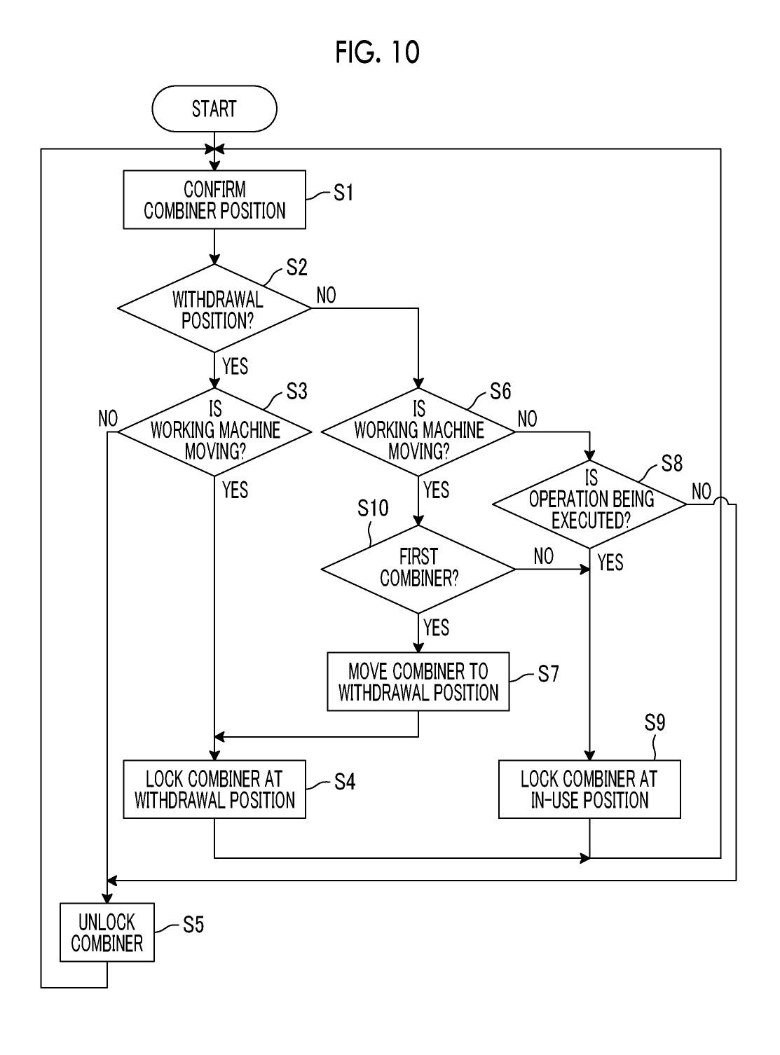

FIG. 10 is a flowchart for illustrating an operation of the HUD 100 that includes the combiner mounting part 150 shown in FIG. 9. In FIG. 10, the same reference numerals are given to the same processes as in FIG. 8, and description thereof will not be repeated. In the flowchart of FIG. 10, an example in which two combiners of a first combiner and a second combiner are present as the combiners 12 capable of being mounted in the combiner mounting part 150, a transmittance of the first combiner is equal to or lower than a threshold, and a transmittance of the second combiner exceeds the threshold will be described.

In a case where it is determined that the traveling state is the moving state in the determination of step S6, the combiner position controller 64 identifies the combiner 12 mounted in the combiner mounting part 150 on the basis of identification information input from the wireless tag reader 15D (step S10). Further, in a case where the identified combiner 12 is the first combiner (YES in step S10), the combiner position controller 64 causes the procedure to proceed to step S7, and in a case where the identified combiner 12 is the second combiner 12 (NO in step S10), the combiner position controller 64 causes the procedure to proceed to step S9.

In this way, even in a case where the combiner 12 is at the in-use position and the traveling state of the construction machine 1 is the moving state, by performing the process of step S7 only in a case where it is expected that the transmittance of the combiner mounted in the combiner mounting part 150 is low and forward visibility is not good, it is possible to reduce power consumption necessary for the position change of the combiner 12. In addition, in a case where a combiner with a low transmittance is mounted, it is possible to secure forward visibility during movement to enhance safety.

In FIG. 10, in a case where the determination of step S10 is NO, the procedure may not proceed to step S5. In this case, it is possible to manually move the combiner 12 during movement, and thus, it is possible to move the combiner 12 as necessary, and to enhance safety during movement.

In the example shown in FIG. 10, the number of combiners capable of being mounted in the combiner mounting part 150 is set to 2, but the number may be three or more. In a case where three or more combiners can be mounted, in step S10, it may be determined whether a combiner having a transmittance that is equal to or lower than a threshold is mounted, and in a case where the combiner having the transmittance that is equal to or lower than the threshold is mounted, the process of step S7 is performed, and in a case where a combiner having a transmittance that exceeds the threshold is mounted, the process of step S9 or step S5 may be performed.

As described above, the following configurations are disclosed in this specification.

(1) There is disclosed a projection type display device includes: a combiner support that is provided in an operator cab of a working machine having a working tool and supports a combiner to be rotatable; a locking mechanism that prohibits rotation of the combiner; a locking mechanism controller that controls the locking mechanism; and a projection display section that spatially modulates light emitted from a light source on the basis of image information, and projects image light obtained through spatial modulation onto a projection surface of the combiner supported by the combiner support to display an image based on the image light, in which the combiner support supports the combiner to be rotatable from an in-use position where the projection surface is inserted onto an optical path of the image light to a withdrawal position where the projection surface is withdrawn from the optical path of the image light, and the locking mechanism controller controls the locking mechanism on the basis of a traveling state of the working machine or an operating state of the working tool.

(2) In the projection type display device according to (1), in a case where the combiner is at the withdrawal position and the working machine is moving, the locking mechanism controller operates the locking mechanism to prohibit the rotation of the combiner.

(3) In the projection type display device according to (2), the combiner support includes a drive section that rotates the combiner in an electrically driven manner, and the projection type display device further includes a combiner position controller that drives the drive section to control the combiner to move to the withdrawal position in a case where the combiner is at the in-use position and the working machine is moving.

(4) In the projection type display device according to (2), the combiner support includes a drive section that rotates the combiner in an electrically driven manner and wherein the combiner support attachably and detachably supports the combiner, the combiner being any one of a plurality of combiners having different transmittances, and the projection type display device further includes: a combiner position controller that drives the drive section to control the combiner to the withdrawal position in a case where the combiner having a transmittance that is equal to or lower than a threshold is supported by the combiner support, the combiner is at the in-use position, and the working machine is moving.

(5) In the projection type display device according to (1), the locking mechanism controller operates the locking mechanism to prohibit the rotation of the combiner in a case where the combiner is at the in-use position and the working tool is in an operating state.

(6) In the projection type display device according to (5), the projection type display device further includes: an operating state determination section that determines that the working tool is in the operating state in a case where contact of an operation member for operating the working tool mounted in the working machine with an object is detected.

(7) There is disclosed a control method of a projection type display device that includes a combiner support that is provided in an operator cab of a working machine having a working tool and supports a combiner to be rotatable, a locking mechanism that prohibits rotation of the combiner, and a projection display section that spatially modulates light emitted from a light source on the basis of image information, and projects image light obtained through spatial modulation onto a projection surface of the combiner supported by the combiner support to display an image based on the image light, in which the combiner support supports the combiner to be rotatable from an in-use position where the projection surface is inserted onto an optical path of the image light to a withdrawal position where the projection surface is withdrawn from the optical path of the image light, the method including: a locking mechanism control step of controlling the locking mechanism on the basis of a traveling state of the working machine or an operating state of the working tool.

(8) In the control method of the projection type display device according to (7), in the locking mechanism control step, in a case where the combiner is at the withdrawal position and the working machine is moving, the locking mechanism is operated to prohibit the rotation of the combiner.

(9) In the control method of the projection type display device according to (8), the combiner support includes a drive section that rotates the combiner in an electrically driven manner, and the method further includes: a combiner position control step of driving the drive section to control the combiner to move to the withdrawal position in a case where the combiner is at the in-use position and the working machine is moving.

(10) In the control method of the projection type display device according to (8), the combiner support includes a drive section that rotates the combiner in an electrically driven manner and wherein the combiner support attachably and detachably supports the combiner, the combiner being any one of a plurality of combiners having different transmittances, and the method further includes: a combiner position control step of driving the drive section to control the combiner to the withdrawal position in a case where the combiner having a transmittance that is equal to or lower than a threshold is supported by the combiner support, the combiner is at the in-use position, and the working machine is moving.

(11) In the control method of the projection type display device according to (7), in the locking mechanism control step, in a case where the combiner is at the in-use position and the working tool is in an operating state, the locking mechanism is operated to prohibit the rotation of the combiner.

(12) In the control method of the projection type display device according to (11), the method further includes: an operating state determination step of determining that the working tool is in the operating state in a case where contact of an operation member for operating the working tool mounted in the working machine with an object is detected.

(13) There is disclosed a non-transitory computer readable medium storing a control program of a projection type display device that includes a combiner support that is provided in an operator cab of a working machine having a working tool and supports a combiner to be rotatable, a locking mechanism that prohibits rotation of the combiner, and a projection display section that spatially modulates light emitted from a light source on the basis of image information, and projects image light obtained through spatial modulation onto a projection surface of the combiner supported by the combiner support to display an image based on the image light, in which the combiner support supports the combiner to be rotatable from an in-use position where the projection surface is inserted onto an optical path of the image light to a withdrawal position where the projection surface is withdrawn from the optical path of the image light, the control program causing a computer to execute: a locking mechanism control step of controlling the locking mechanism on the basis of a traveling state of the working machine or an operating state of the working tool.

According to the invention, it is possible to provide a projection type display device, a control method of the projection type display device, and a control program of the projection type display device, capable of fixing a position of a combiner to a desired position to enhance usability without imposing a burden on an operator of a working machine.

As described above, the invention has been described with reference to specific embodiments, but the invention is not limited to the embodiments, and a variety of modifications may be made in a range without departing from the technical concept of the invention.

This application is based on Japanese Patent Application No. 2016-248119, filed on Dec. 21, 2016, the disclosure of which is incorporated herein by reference.

### EXPLANATION OF REFERENCES

100: HUD
1: construction machine
2: lower traveling body
3: upper revolving body
4: front working part
4A: bucket
4B: boom
4C: arm
5: operator cab
6: cab seat
7: operator
10: projection unit
11: front windshield
12: combiner
12A: projection surface
12B: wireless tag
13: right side pillar
15, 150: combiner mounting part
15A: rotating part
15B: locking mechanism
15C: motor
15D: wireless tag reader
16: optical path
21: right side windshield
22: left side windshield
23: left operation lever
24: right operation lever
40: light source unit
40A: light source controller
41r: R light source
41g: G light source
41b: B light source
42r, 42g, 42b: collimator lens
43: dichroic prism
44: light modulation element
45: drive section
46: projection optical system
47: diffuser
48: reflecting mirror
49: magnifier
50: projection display section
60: system controller
61: operating state determination section
62: traveling state determination section
63: locking mechanism controller
64: combiner position controller
65: display controller
70: storage
80: sensor group
81: vehicle body controller

What is claimed is:

1. A projection type display device comprising:
a combiner support that is provided in an operator cab of a working machine having a working tool and supports a combiner to be rotatable;
a locking mechanism that prohibits rotation of the combiner;
a locking mechanism controller that controls the locking mechanism; and
a projection display section that spatially modulates light emitted from a light source on the basis of image information, and projects image light obtained through spatial modulation onto a projection surface of the combiner supported by the combiner support to display an image based on the image light,
wherein the combiner support supports the combiner to be rotatable from an in-use position where the projection surface is inserted onto an optical path of the image light to a withdrawal position where the projection surface is withdrawn from the optical path of the image light, and
wherein the locking mechanism controller controls the locking mechanism on the basis of a traveling state of the working machine or an operating state of the working tool.

2. The projection type display device according to claim 1,
wherein in a case where the combiner is at the withdrawal position and the working machine is moving, the locking mechanism controller operates the locking mechanism to prohibit the rotation of the combiner.

3. The projection type display device according to claim 2,
wherein the combiner support includes a drive section that rotates the combiner in an electrically driven manner,
the projection type display device further comprising:
a combiner position controller that drives the drive section to control the combiner to move to the withdrawal position in a case where the combiner is at the in-use position and the working machine is moving.

4. The projection type display device according to claim 2,
wherein the combiner support includes a drive section that rotates the combiner in an electrically driven manner and
wherein the combiner support attachably and detachably supports the combiner, the combiner being any one of a plurality of combiners having different transmittances,
the projection type display device further comprising:
a combiner position controller that drives the drive section to control the combiner to the withdrawal position in a case where the combiner having a transmittance that is equal to or lower than a threshold is supported by the combiner support, the combiner is at the in-use position, and the working machine is moving.

5. The projection type display device according to claim 1,
wherein the locking mechanism controller operates the locking mechanism to prohibit the rotation of the combiner in a case where the combiner is at the in-use position and the working tool is in an operating state.

6. The projection type display device according to claim 5, further comprising:
an operating state determination section that determines that the working tool is in the operating state in a case where contact of an operation member for operating the working tool mounted in the working machine with an object is detected.

7. A control method of a projection type display device that includes a combiner support that is provided in an operator cab of a working machine having a working tool and supports a combiner to be rotatable, a locking mechanism that prohibits rotation of the combiner, and a projection display section that spatially modulates light emitted from a light source on the basis of image information, and projects image light obtained through spatial modulation onto a projection surface of the combiner supported by the combiner support to display an image based on the image light,
wherein the combiner support supports the combiner to be rotatable from an in-use position where the projection surface is inserted onto an optical path of the image light to a withdrawal position where the projection surface is withdrawn from the optical path of the image light,
the method comprising:
a locking mechanism control step of controlling the locking mechanism on the basis of a traveling state of the working machine or an operating state of the working tool.

8. The control method of the projection type display device according to claim 7,
wherein in the locking mechanism control step, in a case where the combiner is at the withdrawal position and the working machine is moving, the locking mechanism is operated to prohibit the rotation of the combiner.

9. The control method of the projection type display device according to claim 8,
wherein the combiner support includes a drive section that rotates the combiner in an electrically driven manner,
the method further comprising:
a combiner position control step of driving the drive section to control the combiner to move to the withdrawal position in a case where the combiner is at the in-use position and the working machine is moving.

10. The control method of the projection type display device according to claim 8,
wherein the combiner support includes a drive section that rotates the combiner in an electrically driven manner and
wherein the combiner support attachably and detachably supports the combiner, the combiner being any one of a plurality of combiners having different transmittances,
the method further comprising:
a combiner position controller step of driving the drive section to control the combiner to the withdrawal position in a case where the combiner having a transmittance that is equal to or lower than a threshold is supported by the combiner support, the combiner is at the in-use position, and the working machine is moving.

11. The control method of the projection type display device according to claim 7,
wherein in the locking mechanism control step, in a case where the combiner is at the in-use position and the working tool is in an operating state, the locking mechanism is operated to prohibit the rotation of the combiner.

12. The control method of the projection type display device according to claim 11, further comprising:
an operating state determination step of determining that the working tool is in the operating state in a case where contact of an operation member for operating the working tool mounted in the working machine with an object is detected.

13. A non-transitory computer readable medium storing a control program of a projection type display device that includes a combiner support that is provided in an operator cab of a working machine having a working tool and supports a combiner to be rotatable, a locking mechanism that prohibits rotation of the combiner, and a projection display section that spatially modulates light emitted from a light source on the basis of image information, and projects image light obtained through spatial modulation onto a projection surface of the combiner supported by the combiner support to display an image based on the image light,
wherein the combiner support supports the combiner to be rotatable from an in-use position where the projection surface is inserted onto an optical path of the image light to a withdrawal position where the projection surface is withdrawn from the optical path of the image light,
the control program causing a computer to execute:
a locking mechanism control step of controlling the locking mechanism on the basis of a traveling state of the working machine or an operating state of the working tool.
